(19) United States
(12) Patent Application Publication
(10) Pub. No.: US 2010/0094949 A1
(43) Pub. Date: Apr. 15, 2010

(54) Method of Backing Up Library Virtual Private Database Using a Web Browser

(76) Inventors: Brian Gerard Goodman, Tucson, AZ (US); Leonard George Jesionowski, Tucson, AZ (US)

Correspondence Address: HAMILTON & TERRILE, LLP;IBM Tucson, P.O. BOX 203518, AUSTIN, TX, 78720, US

(21) Appl. No.: 12/251,926

(22) Filed: Oct. 15, 2008

(51) Int. Cl. G06F 15/167; G06F 15/173

(52) U.S. Cl. 709/213; 709/223

(57) ABSTRACT

A library uses a web server to store library vital product data (VPD) to a user's computer. In certain embodiments, the library uses web type cookies to save library VPD as name-value pairs. After an action, such as a service action, that results in a loss of VPD, the library can automatically retrieve the VPD from the web browser of the user's computer. This approach has several advantages. No user intervention is required to back up or restore the library VPD. Simply using the web user interface of the library accomplishes the necessary connection to the user's computer storage. If the user does not connect to the web browser then it is likely that library VPD is not being changed. No additional hardware or software is required. Additionally, the library already has a web server and the customer already uses web browsers to access the library. No cost, installation, or setup is required. In certain embodiments, library firmware can use the existing operator panel and web user interface for prompting the user through any decisions that may be required, as it relates to backing up or restoring library VPD.

### BACKGROUND OF THE INVENTION

1. Field of the Invention

The present invention relates in general to the field of computers and similar technologies, and in particular to automated data storage libraries in this field. Still more particularly, the invention is related to a method of backing up library vital product data (VPD) using a web browser.

2. Description of the Related Art

It is known to use automated data storage libraries to store substantial amounts of data. Automated data storage libraries use a plurality of data storage media, such as magnetic tape and optical cartridges. Accessors transport the media between various sites such as media access drives, storage slots, import/export slots and the like. Often the accessor comprise grippers that move along vertical and/or horizontal rails according to various (x,y) type coordinates. Accessors may also comprise robotic arms and other such devices. Certain libraries use a single accessor, while other libraries can use dual accessors for redundancy or to more quickly carry out media transport requests. Typically, each accessor is managed by one or more library controllers or other similar processing entity.

A library controller directs the movement of its accessor to physically transport media items among various sites in the library. In addition, a library controller maintains various metadata regarding the accessor and the library. One example of this metadata is vital product data (VPD). Vital product data refers to nonvolatile data and may include calibration data and configuration data. Calibration data includes a set of tuning values that allows a system to perform mechanical motions with a high degree of accuracy and repeatability. For example, calibration data correlates mechanical grippers to certain physical locations in the library. This data is usually formed at the factory and/or the customer site. Configuration data describes an overall configuration of the library system and library components. Some examples of configuration data may include a number and type of robotic devices, any additional attachments or options, optional characteristics of the system, part numbers or model numbers of the library and library components, engineering change levels, the number of frames or modules in the library, number and location of storage slots in each frame, number and location of import/export stations, number and location of read/write drives, IP addresses for network attachment, serial number of the library and library components, World Wide Name of the library and library components, etc. The configuration data can also include user settings such as, for example, operator panel backlight time-out, library or logical library names, etc. The VPD is usually stored within the library controller. If the library is serviced and the library controller needs replacement then the VPD may be lost.

It is known to provide a user with the option of saving a backup copy of the VPD by down loading a file from their web browser. An issue with this approach is that it relies on the end-user to make periodic backups. Users may not perform such backup operations and when they do, they may be infrequent and down level from the current state of the library. In addition, when a repair action is performed on the library, the particular user that performed the backup and/or the actual backup file may not be available to restore the library VPD.

Additionally, certain known libraries may provide their own backup of the VPD. For example, the library controller may contain the primary copy of VPD while the accessor (or another component of the library) may contain a backup copy of the VPD. As a result, a service action or replacement of either the library controller or the accessor would not result in a loss of the VPD. An issue with this approach is the added cost and complexity of adding nonvolatile memory to another component of the library. In addition, some libraries do not have service actions for individual components of the library. In this case, the entire library is a replacement component and it would not do any good to have a backup copy of the VPD in any component of the library because the entire library could be replaced during a service action.

It is known to provide automated data storage libraries with a web user interface to perform library management functions. Many libraries require the use of the web user interface to perform basic set-up and configuration tasks. For example, the TS3200 tape library available from International Business Machines, uses a web user interface to partition the library, to enable and set up encryption, to manage library security, etc.

### SUMMARY OF THE INVENTION

In accordance with the present invention, a library uses a web browser to store library VPD to a user's computer. In certain embodiments, the library uses web type cookies to save library VPD as name-value pairs. After an action, such as a service action, that results in a loss of VPD, the library can automatically retrieve the VPD from the web browser of the user's computer. This approach has several advantages. No user intervention is required to back up or restore the library VPD. Simply using the web user interface of the library accomplishes the necessary connection to the user's computer storage. If the user does not connect to the web browser then it is likely that library VPD is not being changed. No additional hardware or software is required. Additionally, the library already has a web server and the customer already uses web browsers to access the library. No cost, installation, or setup is required. In certain embodiments, library firmware can use the existing library interface(s) (operator panel and/or web user interface) for prompting the user through any decisions that may be required, as it relates to backing up or restoring library VPD.

In operation, when a user accesses a library via a web user interface, the library obtains information from the user's web browser. This information may comprise part or all of the library VPD that was previously backed up to the web browser. This information may be stored in the form of cookies, where the library VPD is stored as name-value pairs. If the web browser VPD does not match the library VPD, then the library determines if the library copy of VPD is more current, or if the web browser copy of VPD is more current. If the library copy is more current, then the library provides part or all of its VPD to the web browser in order to have a more current backup copy. If the web browser copy is more current, then the library uses part or all of the web browser VPD to restore the library VPD to its backed up state (the state prior to a service action or other action that resulted in the loss of library VPD). The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings.

FIG. 1 shows a block diagram of the hardware components and interconnections of an automated data storage library.

FIG. 2 shows a block diagram of a digital data processing system.

FIG. 3 shows a flow chart of the operation of a system for backing up library vital product data (VPD) using a web browser.

FIG. 4 shows a flow cart of a restore operation of the system for backing up library VPD information using a web browser.

### DETAILED DESCRIPTION

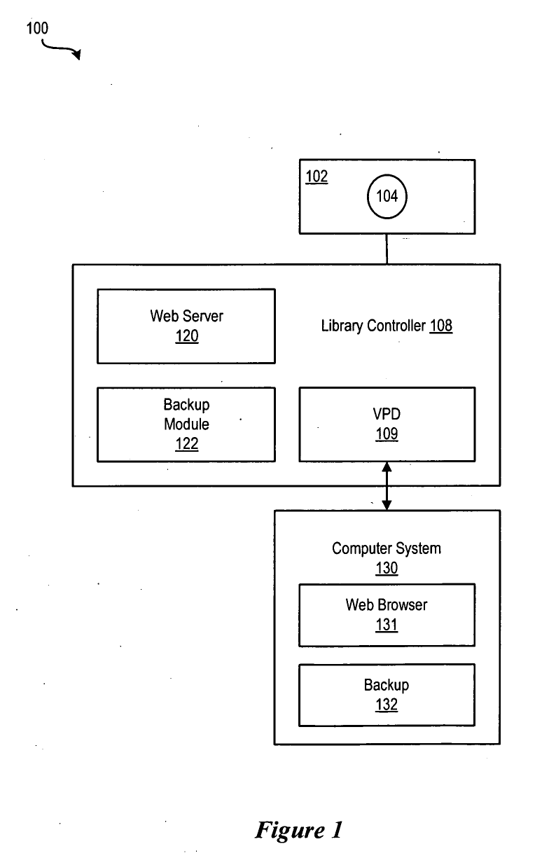

One aspect of the present invention relates to an automated data storage library, which may be embodied by various hardware components and interconnections, with one example being described by the automated data storage library 100 of FIG. 1. The library is designed to house, transport, read data from, and/or write data to portable data storage media. Data storage media may comprise any type of media on which data may be stored and which may serve as removable media, including but not limited to, magnetic media (such as magnetic tape or disks), optical media (such as optical tape or disks), holographic media (such as holographic tape, disks, cards, etc.), electronic media (such as PROM, EEPROM, flash PROM, MRAM, Compact Flash™, Smart Media™, Memory Stick™, Secure Digital™, Solid State Drives, etc.), or MEMS based media (such as IBM's Millipede). The library 100 includes library infrastructure 102, such as media access drives or circuits, storage slots, import/export slots, accessors 104, etc. The accessors comprise electromechanical devices to grip, release, identify and transport items of portable data storage media. The accessors 104 may also perform calibration and other known tasks not directly related to media movement of media items.

The accessor 104 moves in accordance with analog signals, digitals signals, and/or complex commands transmitted by one or more library controllers 108. The controller 108 may comprise one or more workstations, computers, processors, FPGA, ASIC, discrete logic, etc. In addition, the controller 108 may comprise one or more processing threads (such as an application program, device driver, function, subroutine, code sequence, programming object, processor instructions, etc.).

The controller 108 also comprises associated VPD 109 which is stored in one or more nonvolatile components. The nonvolatile component(s) may comprise electronic devices such as battery backed up RAM, EEPROM, Flash PROM, FRAM, Secure Digital Media, CompactFlash, etc. In addition, the nonvolatile component(s) may comprise magnetic devices (such as hard drives), optical devices (such as optical disk, tape, or cards), electro-mechanical devices (such as MEMS based storage), etc. The VPD storage may comprise hardware and/or software components as appropriate to the implementation of the controller 108. The VPD storage may store VPD information including calibration data and configuration data. The calibration data may include a set of tuning values that allow a system to perform mechanical motions with a high degree of accuracy and repeatability. For example, calibration data correlates mechanical grippers to certain physical locations in the library. This data is usually formed at the factory and/or the customer site. The configuration data describes an overall configuration of the library system and library components. Some examples of configuration data include a number and type of robotic devices, any additional attachments or options, optional characteristics of the system, part numbers or model numbers of the library and library components, engineering change levels, the number of frames or modules in the library, number and location of storage slots in each frame, number and location of import/export stations, number and location of read/write drives, IP addresses for network attachment, serial number of the library and library components, World Wide Name of the library and library components, etc. The configuration data can also include user settings such as, for example, operator panel backlight time-out, library or logical library names, etc. Although certain examples of vital product data are set forth, the concepts of this disclosure may be applied without limitation to other types of product, system, component or other data which may generally be referred to as metadata.

The controller 108 also comprises a web server 120 as well as a backup module 122. Backup module 122 is a hardware and/or software component of library controller 108. Herein, backup module and library controller may be used interchangeably. The library controller 108 along with backup module 122 may monitor VPD 109. This may comprise updating part or all of VPD 109 as conditions change within the library 100. For example, library controller 108 may recalibrate part of the library as the result of an error recovery procedure (ERP). Since calibration values may be stored in VPD 109, it may be necessary to update VPD 109 as the result of the ERP and subsequent recalibration. Another example of monitoring by the library controller 108 and/or the backup module 122 may comprise a validity check. The validity check may be performed at power-on, at some periodic interval, when a web browser establishes a connection with the web server, through a command at a user interface of the library, after an update to VPD 109, as the result of an ERP, etc. The controller 108 may also be coupled to a computer system 130 such as a workstation, personal computer, laptop, portable multi-function device (such as PDA or cell phone), or any other computing device capable running a web browser application and capable of establishing a wired or wireless network connection to a local, private, or public network, or directly to another device.

The user computer system 130 comprises backup storage 132 and web browser 131. The library 100 uses the web server 120 to store part or all of library VPD 109 to a user's computer 130 within the backup storage 132, by using web browser 131. In certain embodiments, the library 100 uses web type cookies to access library VPD 109 as name-value pairs. Cookies allow web sites to provide a more personal experience for users accessing those web sites. For example, cookies may be used to store user preferences in terms of how the web page is displayed. In another example, cookies may be used to store information about the users buying preferences (age, gender, tastes or interests, etc.). Cookies are related to an IP address or domain name of a web server. This allows different web sites to store their own cookies on a user's machine. Each user machine that accesses the same web site will be updated with its own cookie file. Therefore, if there are a lot of machines that access a particular library then there could be a lot of different cookie files. The normal use of a remote management interface on a library helps to eliminate the potential variation of data that could be present in cookie files. For example, some of the library VPD is static such as World Wide Names, MAC addresses, serial numbers, license keys, etc. As a result, backing up and restoring static data does not really present a problem with the age or version of the data. In another example, data processing equipment typically has a limited number of administrators who in turn tend to use a limited number of different computers to access their libraries. This helps to control the number of different cookie files and therefore different versions of data (VPD). Still further, the VPD could be date and/or time tagged such that the library could determine when the content of the data differs between the library VPD and the backup up VPD. Any differences could compare the date/time of the library VPD to the date/time of the backup VPD. The more recent data would be used to restore the restore the library VPD either directly, or after prompting a user for which actions should be taken (no actions, restore the library VPD, overwrite the backup VPD). After an action, such as a service action, that may result in a loss of VPD, the library 100 can automatically retrieve the VPD from the web browser 131 of the user's computer 130. In certain embodiments, library firmware can use an existing operator panel and web user interface for prompting the user through any decisions that may be required, as it relates to backing up or restoring library VPD 109.

In operation, when a user accesses the library 100 via the web user interface of web server 120, the library obtains information from the user's web browser. This information may comprise part or all of the library VPD that was previously backed up to back-up 132 (via the web browser 131). This information may be stored in the form of cookies, where the library VPD is stored as name-value pairs. Some of the information may comprise information unique to a particular library, herein referred to as a library identifier. The library identifier may comprise a library serial number, serial number or other identifier of a component within the library, world wide name, MAC address, random number, library name, or any other information that may be used to tell one library from another. If there is no back-up 132, or the back-up 132 contains no library identifier, then part or all of the library VPD 109 is saved to backup-132 using web browser 131. One reason for not having a matching library identifier is that web browser 131 may not have accessed a library at the current IP address or domain name. This is because cookies are stored for a particular IP address or domain name and the current IP address may have not been used for a library connected to web browser 131 before. In one embodiment, when there is no back-up 132 or when there is no library identifier in back-up 132, the web server 120 stores part or all of VPD 109 to back-up 132 using web browser 131. This provides a remote back-up in the event that a service action is later performed on library 100. If the library identifier in VPD 109 matches the identifier saved in back-up 132, then the web server 120 may store part or all of VPD 109 to back-up 132 using browser 131. This provides a more recent back-up in the event that a service action is later performed on library 100. If back-up 132 contains a library identifier that is different than the library identifier in VPD 109, then it may be desired to prompt the user to make a decision about the action that the library should take. For example, the library identifier in VPD 109 may not match the library identifier in back-up 132 because a service action may have been performed. In this case, it would be desired to restore some or all of the VPD in the back-up 132 of the computer system 110 to the VPD 109 of the library 100. In another example, the library identifier in VPD 109 may not match the library identifier in back-up 132 because the web browser 131 may have previously used the same IP address or domain name for accessing another library. In this case, it would be desired to back up some or all of the VPD 109 to back-up 132. This is because the VPD stored in back-up 132 would not be a valid backup for VPD 109 since it belongs to another library that previously used the same IP address or domain name. Since cookie storage is based on IP addresses or domain names, it may be desired to replace the VPD in the back-up 132 of the computer system 110 with VPD 109 of the library 100. If the web browser VPD does not match the library VPD, then the library determines if the library copy of VPD is more current, or if the web browser copy of VPD is more current. If the library copy is more current, then the library provides part or all of its VPD to the web browser to have a more current backup copy. If the web browser copy is more current, then the library uses part or all of the web browser VPD to restore the library VPD to its backed up state (the state prior to a service action or other action that resulted in the loss of library VPD). In one embodiment, if back-up 132 contains a library identifier that is the same as the library identifier in VPD 109, then library controller 108 will copy some or all of VPD 109 to back-up 132. In one embodiment, if back-up 132 contains a library identifier that is different than the library identifier in VPD 109, then library controller 108 will copy some or all of back-up 132 to VPD 109. In one embodiment, if back-up 132 contains a library identifier that is different than the library identifier in VPD 109, then library controller 108 will prompt the user for an action. In another embodiment, one action comprises library controller 108 copying some or all of back-up 132 to VPD 109. In another embodiment, one action comprises library controller 108 copying some or all of VPD 109 to back-up 132. In another embodiment, the prompting includes part or all of the library identifier stored in VPD 109. In another embodiment, the prompting includes part or all of the library identifier stored in back-up 132. In another embodiment, the prompting includes the date and/or time that the back-up 132 was last modified or saved.

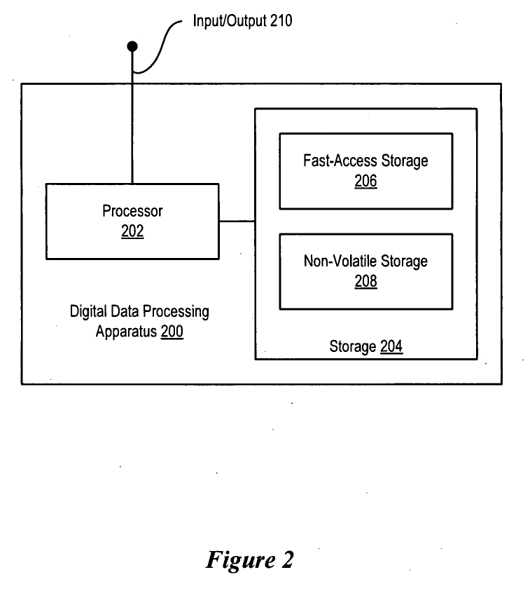

The library controller 108 and the computer system 130 may be implemented in various forms. For example, the library controller 108 and the computer system 130 may each be implemented as a digital data processing apparatus, as exemplified by the hardware components and interconnections of the digital data processing apparatus 200 of FIG. 2.

The apparatus 200 includes one or more processors 202, such as a microprocessor, FPGA, ASIC, discrete logic, etc., coupled to storage 204. In the present example, the storage 204 includes fast access storage 206 used to store programming instructions executed by the processor 202 and may be embodied by random access memory (RAM) or one or more other types of fast access storage media. The non volatile storage 208 may comprise, for example, battery backup RAM, Flash programmable read only memory (PROM), electrically erasable PROM (EEPROM), one or more magnetic data storage disks such as a hard drive, a tape drive or other suitable storage device. The apparatus 200 also includes an input/output 210, such as a line, bus, cable, electromagnetic link, or other means for the processor 202 to exchange data with other hardware external to the apparatus.

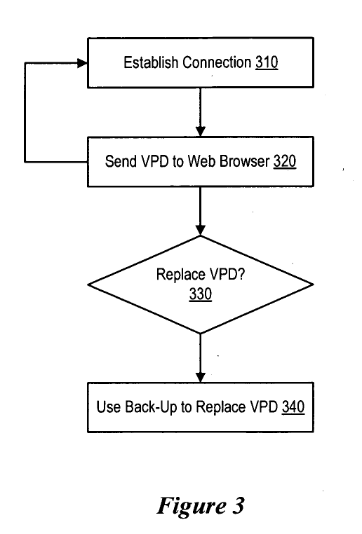

Referring to FIG. 3, under normal operation, a user may establish a connection between a web browser and the library web server at step 310. The library may send part or all of its VPD 109 to the web browser to ensure that the backup copy is current at step 320. For example, the library may use cookies to save name-value pairs that are associated with library VPD. Step 320 may include a check to prevent the backup copy from being corrupted. For example, a library identifier may be used to determine if both the primary (VPD 109) and backup (back-up 132) copy of VPD are related to each other. If they are not related to each other, then one must be incorrect data for the particular library that the connection was established with in step 310. If the primary copy is determined to be incorrect, then step 320 may not be executed.

If it is determined that it is necessary to replace part or all of the library VPD 109 at step 330, then the library controller 108 performs a restore operation using the VPD information that is stored within the backup storage location 132 at step 340. Steps 330 and 340 may be executed at different times than steps 310 and 320. For example, steps 330 and/or 340 may be executed prior to steps 310 and/or 320.

It may be determined that it is necessary to replace the library VPD 109 based upon performance of a library repair action. The library repair action may result in a loss of library VPD 109. For example, a library repair action may occur when the library controller 108 is replaced. In another example, the library controller 108 and the component that contains a backup copy of the VPD (not shown) may have both been replaced. Still further, the entire library may be replaced. When any of these actions occur, it may be necessary to replace the library VPD 109. When it is necessary to replace the library VPD, the library may optionally display a message on a user interface associated with library controller 108 (such as an operator panel or web user interface). This message may request that the user access the library through another user interface. Alternatively, the message may request that the user make a decision about which action the library controller 108 should take. For example, perform a backup operation (copy part or all of VPD 109 to back-up 132), perform a restore operation (copy part or all of back-up 132 to VPD 109), do nothing, etc.

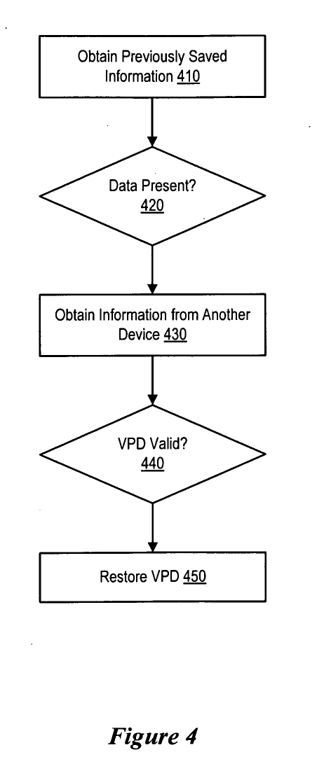

Referring to FIG. 4, a flow chart of the operation of a restore operation is shown. More specifically, when a user accesses the library through a web user interface after VPD 109 has been lost, the library obtains information that has been previously saved by the web browser 120 to a backup storage location 132 at step 410. Lost VPD data may refer to some or all of the data being missing, corrupted, not related to the back-up 132, etc. In addition, step 410 may be executed without any regard to lost VPD 109 data. For example, it may be necessary to obtain some or all of the back-up 132 in order to determine if data has been lost. The information may be obtained through the use of Cookies. For example, cookies may be sent to the library. These cookies may contain part or all of the library VPD in the form of name-value pairs. In the event that no data has been saved by the currently attached web browser as determined at step 420, the library may instruct the user to access the library through another computer and/or another web browser that may contain the missing information at step 430.

Once the VPD has been obtained, the library may check the VPD to be certain that it is associated with the library being accessed (i.e. is valid) at step 440. This may be desired to support more than one library with a single web browser. This may also be desired to prevent a library from overwriting the backup data with data from a newly replaced component (i.e. overwriting the golden copy). This check may comprise a library identifier, as described above. On example of a library identifier is the library serial number. In this case, a name-value pair may be used to store the library serial number. Some library manufacturers require that library serial numbers be maintained, even after a service action. Most serial numbers are stored electronically as well as visually somewhere on the library hardware. If the library identifier of the VPD 109 does not match the library identifier in the backup 132, the library may prompt a user for action. The user may be prompted on a user interface (such as an operator panel, web user interface, other remote interface or computer, etc.). The prompting may ask the user to confirm if a component has been replaced. Additional information may be provided by the library to assist the user with a decision. For example, the two library identifiers may be provided, the date/time of the last modification to the backup copy may be provided, etc. If no component has been replaced then the mismatch may be due to an old backup (cookie file) or may be due to another library that previously used the same IP address or domain name. Alternatively, the prompting may ask the user to enter the original library identifier. If the entered library identifier matches the identifier in backup 132, then a restore operation may be performed to copy part or all of backup 132 to VPD 109. If the entered library identifier matches the identifier in VPD 109, then a backup operation may be performed to copy part or all of VPD 109 to backup 132. In one embodiment, a mismatch between a library identifier in VPD 109 and the identifier in back-up 132 results in the user being prompted to restore the VPD. If the user answers “yes” then part or all of the VPD in back-up 132 is copied to VPD 109. If the user answers “no,” then the user is prompted to over write the VPD. If the user answers “yes” then part or all of VPD 109 is copied to back-up 132. If the user answers “no” then no VPD action is taken. In one embodiment, if the user answered “no” to both questions then the library would continue to prompt the user to take action. This continued prompting may occur at each library reset, each time a change is made to VPD 109, at some periodic interval, or combinations thereof.

Since multiple browsers may have been used to access the library, and since one browser may have a more current version of VPD than another browser, it may be desired to handle this case. One approach is to assign a version number to the data. For example, when a library is manufactured, the VPD version may be set to a value of zero. Each time the VPD is changed, the VPD version may be incremented. When the library finds that its current version is less than the version that a web browser has, it may update to the later version or it may allow the user to make a decision about updating to the later version.

After the library controller determines that the VPD information is valid, then the library controller restores the VPD information to the library system at step 450.

The library may have controls to further limit the backup and restoration of library VPD. For example, the library may only allow VPD to be backed up and/or restored if the user is logged into the library web server with administrator privileges.

This invention has been described as using cookies to allow the web server to work with the web browser to automatically back up and/or restore library VPD. Those skilled in the art will recognize that other similar techniques for using a web browser to save web server information may be used. These may include, without limitation, Macromedia Flash® local stored objects, JavaScript® using DOM property window.name, client side persistence, etc. In addition, the web server may be replaced with a java application that may or may not run on the computer system 110. In this case, web browser 131 may run or launch the java application (or java applet) on computer system 110 and a java application, web server, or simply a TCP/IP stack on accessor controller 108 may provide the communication for the java application.

It should be understood that at least some aspects of the present invention might alternatively be implemented in a computer-usable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDAs), telephones, and any other system capable of processing, transmitting, receiving, capturing and/or storing data.

What is claimed is:

1. A method for operating an automated data storage library, the automated data storage library comprising a web server, a media accessor and a library controller, the library controller storing vital product data relating to the automated data storage library, the method comprising
monitoring the vital product data during operation of the library;
automatically storing the vital product data to a backup storage location via a web server of the library controller and a web browser of the backup storage location;
accessing the vital product data at the backup storage location via the web browser and the web server and storing it to the library controller if the vital product data stored within the library controller is lost.

2. The method of claim 1 wherein:
the backup storage location comprises a web type cookie stored on a data processing apparatus separate from the library controller.

3. The method of claim 2 wherein:
the web type cookie saves the vital product data as name-value pairs.

4. The method of claim 1 wherein:
the vital product data comprises at least one from the set of calibration data, configuration data, user settings, library serial number, world wide name, MAC address.

5. The method of claim 1 wherein:
the vital product data stored in the library controller comprises a library identifier and the vital product data stored in the backup storage location comprises a library identifier, and wherein the automatically storing step additionally comprises storing the vital product data to the backup storage location only if the library identifier of the library controller matches the library identifier of the backup storage location.

6. The method of claim 1 wherein:
the vital product data stored in the library controller comprises a library identifier and the vital product data stored in the backup storage location comprises a library identifier, and wherein the accessing step additionally comprises storing the vital product data to the library controller only if the library identifier of the library controller does not match the library identifier of the backup storage location.

7. The method of claim 1 wherein:
the vital product data stored in the library controller comprises a library identifier, the vital product data stored in the backup storage location comprises a library identifier and a user is prompted for an action for the library controller to execute when the library identifier of the library controller does not match the library identifier of the backup storage location.

8. The method of claim 7 wherein:
the action comprises the automatically storing step.

9. The method of claim 7 wherein:
the action comprises the accessing step.

10. The method of claim 1 wherein:
lost vital product data comprises at least one from the set of missing, corrupted, not related to the vital product data at the backup storage location.

11. An apparatus for operating an automated data storage library, the automated data storage library comprising a web server, a media accessor and a library controller, the accessor controller storing vital product data relating to the automated data storage library, the method comprising
means for monitoring the vital product data during operation of the library;
means for automatically storing the vital product data to a backup storage location via a the web server of the library controller and a web browser of the backup storage location;
means for accessing the vital product data at the backup storage location via the web browser and the web server and storing it to the library controller if the vital product data stored within the library controller is lost.

12. The apparatus of claim 11 wherein:
the backup storage location comprises a web type cookie stored on a data processing apparatus separate from the library controller.

13. The apparatus of claim 12 wherein:
the web type cookie saves the vital product data as name-value pairs.

14. The apparatus of claim 11 wherein:
the vital product data comprises at least one from the set of calibration data, configuration data, user settings, library serial number, world wide name, MAC address.

15. The apparatus of claim 11 wherein:
the vital product data stored in the library controller comprises a library identifier and the vital product data stored in the backup storage location comprises a library identifier, and wherein the automatically storing step additionally comprises storing the vital product data to the backup storage location only if the library identifier of the library controller matches the library identifier of the backup storage location.

16. The apparatus of claim 11 wherein:
the vital product data stored in the library controller comprises a library identifier and the vital product data stored in the backup storage location comprises a library identifier, and wherein the accessing step additionally comprises storing the vital product data to the library controller only if the library identifier of the library controller does not match the library identifier of the backup storage location.

17. The apparatus of claim 11 wherein:
the vital product data stored in the library controller comprises a library identifier, the vital product data stored in the backup storage location comprises a library identifier and a user is prompted for an action for the library controller to execute when the library identifier of the library controller does not match the library identifier of the backup storage location.

18. The apparatus of claim 17 wherein:
the action comprises the automatically storing step.

19. The apparatus of claim 17 wherein:
the action comprises the accessing step.

20. The apparatus of claim 11 wherein:
lost vital product data comprises at least one from the set of missing, corrupted, not related to the vital product data at the backup storage location.

21. An automated data storage library comprising
a web server;
a media accessor;
a library controller coupled to the media accessor, the library controller storing vital product data relating to the automated data storage library,
a backup module, the backup module comprising instructions executable by the library controller for:
monitoring the vital product data during operation of the library;
automatically storing the vital product data to a backup storage location via the web server of the library controller and a web browser of the backup storage location;
accessing the vital product data at the backup storage location via the web browser and the web server and storing it to the library controller if the vital product data stored within the library controller is lost.

22. The automated data storage library of claim 21 wherein:
the backup storage location comprises a web type cookie stored on a data processing apparatus separate from the library controller.

23. The automated data storage library of claim 22 wherein:
the web type cookie saves the vital product data as name-value pairs.

24. The automated data storage library of claim 21 wherein:
the vital product data comprises at least one from the set of calibration data, configuration data, user settings, library serial number, world wide name, MAC address.

25. The automated data storage library of claim 21 wherein:
the vital product data stored in the library controller comprises a library identifier and the vital product data stored in the backup storage location comprises a library identifier, and wherein the automatically storing step additionally comprises storing the vital product data to the backup storage location only if the library identifier of the library controller matches the library identifier of the backup storage location.

26. The automated data storage library of claim 21 wherein:
the vital product data stored in the library controller comprises a library identifier and the vital product data stored in the backup storage location comprises a library identifier, and wherein the accessing step additionally comprises storing the vital product data to the library controller only if the library identifier of the library controller matches the library identifier of the backup storage location.

27. The automated data storage library of claim 21 wherein:
the vital product data stored in the library controller comprises a library identifier, the vital product data stored in the backup storage location comprises a library identifier and a user is prompted for an action for the library controller to execute when the library identifier of the library controller does not match the library identifier of the backup storage location.

28. The automated data storage library of claim 27 wherein:
the action comprises the automatically storing step.

29. The automated data storage library of claim 27 wherein:
the action comprises the accessing step.

30. The automated data storage library of claim 21 wherein:
lost vital product data comprises at least one from the set of missing, corrupted, not related to the vital product data at the backup storage location.
